(19) United States
(12) Patent Application Publication
(10) Pub. No.: US 2020/0265304 A1
(43) Pub. Date: Aug. 20, 2020

(54) SYSTEM AND METHOD FOR IDENTIFYING MISCLASSIFICATIONS BY A NEURAL NETWORK

(71) Applicant: Wipro Limited, Bangalore (IN)

(72) Inventors: Bangalore Nagaraj Chandrashekar, Bangalore (IN); Manjunath Ramachandra lyer, Bangalore (IN); Pallavi Ramesh Naik, Bangalore (IN)

(21) Appl. No.: 16/368,894

(22) Filed: Mar. 29, 2019

(30) Foreign Application Priority Data
Feb. 14, 2019 (IN) 201941005926

(51) Int. Cl. G06N 3/08; G06N 20/00

(52) U.S. Cl. CPC G06N 3/08; G06N 20/00

(57) ABSTRACT

A method and system of identifying misclassification in a neural network is disclosed. The method includes generating for an input image, an image heatmap associated with each of a plurality of layers of a neural network. The method further includes determining for the input image, an activation value at each of the plurality of layers based on the associated image heatmap. The method includes identifying for the input image, a first pattern of triggered neurons of the plurality of layers based on the activation value generated for the plurality of layers. The method further includes comparing for each of the plurality of classes, a second pattern of triggered neurons with the first pattern of triggered neurons identified at the at least one of the plurality of layers. The method includes identifying, misclassification of the input image in the neural network based on a result of the comparison.

### TECHNICAL FIELD

This disclosure relates generally to neural networks, and more particularly to system and method for identifying misclassifications by a neural network.

### BACKGROUND

One of the issues in deep learning model is opacity in decision-making. To help in getting a better picture of working of the model, model visualization tools have been developed. In this deep learning model, explanation for the decision making is also available in text form. The conventional solutions provide a glimpse of explanation in the form of heat maps (for example, layer-wise relevance or saliency-based heat maps), text explanation, or visualization of activations of each neuron contributing to results in different layers.

However, the explanation provided by different algorithms may be available in bits and pieces independently, making it difficult to corroborate and understand the behavior of a given network. Further, there is no single solution to link and combine at least one of an optimal training set selection, a relevance based heat map, a text explanation, a model visual explanation and a misclassification identification in the iterative design of the explainable classifier. Also, there is no mechanism to link the text explanation with the relevance of a certain layer of the deep learning network so that the explanation is assured to be relevant.

Further, the text explanation generated for classification is based on the labelled training data of the model. Today, generation of this labelled data is highly subjective and non-trivial, given the subtle difference among the elements of a class in the training set. There is no mechanism to identify most relevant regions in the input image contributing to the class and prompt the expert to use their attributes in the explanation while labelling the data. Today, the available explainable Artificial Intelligence (AI) models can provide reason behind the classification. However, there is no mechanism to identify the potential misclassification by the classifier in a deployed model. An alert on misclassification to the user would be helpful in preventing the error from getting into the system.

One of the reasons for the misclassification is the reduced interclass distance where a certain outlier or fringe elements a class can share many features of adjacent class in common. Today there is no mechanism to tell the number of subclasses in a given class and if it makes sense to club the closely related subclasses of two adjacent classes into a new class and thereby achieve right classification.

In some conventional methods, an explanation for database transaction models is provided based on if-then-else structure or reasoning. However, this is static in nature and not applicable to deep learning classifier models. In some conventional systems, a user may visualize features and interactively group them based on similarity. A k-mean clustering is supported to group similar features and come out with average feature of cluster to reduce duplication of computation. This helps to trace the flow of features. However, this system does not consider the importance or relevance of features. Moreover, clustering is not done based on output classes.

### SUMMARY

In one embodiment, a method of identifying misclassifications by a neural network is disclosed. In one embodiment, the method may include generating for an input image, an image heatmap associated with each of a plurality of layers of the neural network, wherein the input image is associated with a class of a plurality of classes. The method may further include determining for the input image, an activation value at each of the plurality of layers based on the associated image heatmap, wherein the activation value for a layer of the plurality of layers corresponds to a weighted sum of a plurality of neurons in the layer. The method may further include identifying for the input image, a first pattern of triggered neurons in at least one of the plurality of layers based on the activation value generated for the at least one of the plurality of layers. The method may further include comparing for each of the plurality of classes, a second pattern of triggered neurons with the first pattern of triggered neurons identified at the at least one of the plurality of layers, wherein, for each of the plurality of classes, the second pattern of triggered neurons is identified for a penultimate layer of the plurality of layers, based on an activation value generated at the penultimate layer. The method may further include identifying, a misclassification of the input image in the neural network based on a result of the comparison.

In another embodiment, a system for identifying misclassification in a neural network is disclosed. The system includes a processor and a memory communicatively coupled to the processor, wherein the memory stores processor instructions, which, on execution, causes the processor to generate for an input image, an image heatmap associated with each of a plurality of layers of the neural network, wherein the input image is associated with a class of a plurality of classes. The processor instructions further cause the processor to determine for the input image, an activation value at each of the plurality of layers based on the associated image heatmap, wherein the activation value for the layer of the plurality of layers corresponds to the weighted sum of a plurality of neurons in the layer. The processor instructions cause the processor to identify for the input image, a first pattern of triggered neurons in at least one of the plurality of layers based on the activation value generated for the at least one of the plurality of layers. The processor instructions further cause the processor to compare for each of the plurality of classes, a second pattern of triggered neurons with the first pattern of triggered neurons identified at the at least one of the plurality of layers, wherein, for each of the plurality of classes, the second pattern of triggered neurons is identified for a penultimate layer of the plurality of layers, based on an activation value generated at the penultimate layer. The processor instructions cause the processor to identify, the misclassification of the input image in the neural network based on the result of the comparison.

In yet another embodiment, a non-transitory computer-readable storage medium is disclosed. The non-transitory computer-readable storage medium has instructions stored thereon, a set of computer-executable instructions causing a computer comprising one or more processors to perform steps comprising generating for an input image, an image heatmap associated with each of a plurality of layers of a neural network, wherein the input image is associated with a class of a plurality of classes; determining for the input image, an activation value at each of the plurality of layers based on the associated image heatmap, wherein the activation value for the layer of the plurality of layers corresponds to the weighted sum of a plurality of neurons in the layer; identifying for the input image, a first pattern of triggered neurons in at least one of the plurality of layers based on the activation value generated for the at least one of the plurality of layers; comparing for each of the plurality of classes, a second pattern of triggered neurons with the first pattern of triggered neurons identified at the at least one of the plurality of layers, wherein, for each of the plurality of classes, the second pattern of triggered neurons is identified for a penultimate layer of the plurality of layers, based on the activation value generated at the penultimate layer; and identifying, misclassification of the input image in the neural network based on the result of the comparison.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating an exemplary system for identifying misclassifications by a neural network, in accordance with an embodiment.

FIG. 2 is a functional block diagram illustrating an identification engine configured to identifying misclassifications by a neural network, in accordance with an exemplary embodiment.

FIG. 3 illustrates a flowchart of a method for identifying misclassifications by a neural network, in accordance with an embodiment.

FIG. 4 illustrates a flowchart of a method for generating a dictionary that includes a mapping of a plurality of attributes with an associated textual description, in accordance with an embodiment.

FIG. 5 illustrates generation of a dictionary using one or more activation images, in accordance with an exemplary embodiment.

FIG. 6 illustrates a flowchart of a method for displaying textual description for each of a plurality of mismatching attributes based on a dictionary, in accordance with an exemplary embodiment.

FIGS. 7A and 7B illustrate a flowchart of a method for identifying misclassification based on simple classification and complex classification techniques implemented in a neural network, in accordance with an embodiment.

FIG. 8 illustrates a graph depicting layer-wise learning for a neural network with simple classification and a graph depicting layer-wise learning for a neural network with complex classification, in accordance with an embodiment.

FIG. 9 illustrates a graph representing activation and relevance of neurons in a neural network with simple classification to identify misclassification in the neural network, in accordance with an embodiment.

FIG. 10 is a block diagram of an exemplary computer system for implementing embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description may be considered as exemplary only, with the true scope and spirit being indicated by the following claims. Additional illustrative embodiments are listed below.

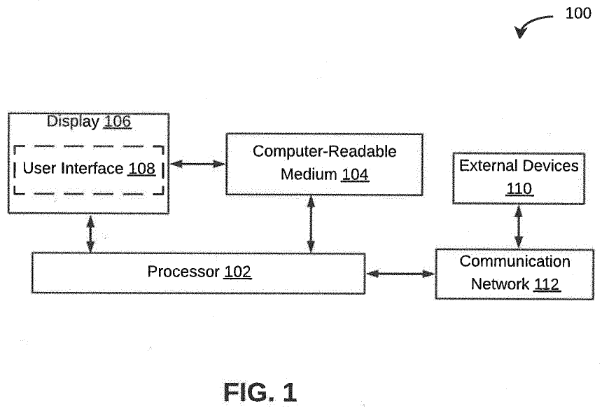

Referring now to FIG. 1, an exemplary system 100 for identifying misclassifications by a neural network is illustrated, in accordance with an embodiment. As will be appreciated, the system 100 may be implemented in the neural network in order to identify misclassification in the neural network. Further, the system 100 may be implemented in an identification engine. The identification engine may improve performance and accuracy of the neural network by identifying misclassifications. In particular, the system 100 may include an identification device (for example, a server, a desktop, a laptop, a notebook, a netbook, a tablet, a smartphone, a mobile phone, or any other computing device) that may be implemented in the identification engine.

The system 100 may include a processor 102, a computer-readable medium 104 (for example, a memory), and a display 106. The computer-readable medium 104 may store instructions that, when executed by the processor 102, may cause the processor 102 to identify misclassifications by the neural network. The computer-readable medium 104 may also store various data (for example, a predefined threshold, a degree of mismatch, a dictionary and the like) that may be captured, processed, and/or required by the system 100. The system 100 may interact with a user via a user interface 108 accessible via the display 106. The system 100 may also interact with one or more of an external device 110 over a communication network 112 for sending or receiving various data. The external devices 110 may include but are not limited to a remote server, a digital device, or another computing system. The system 100 may be adapted to exchange data with other components or service providers using the communication network 112.

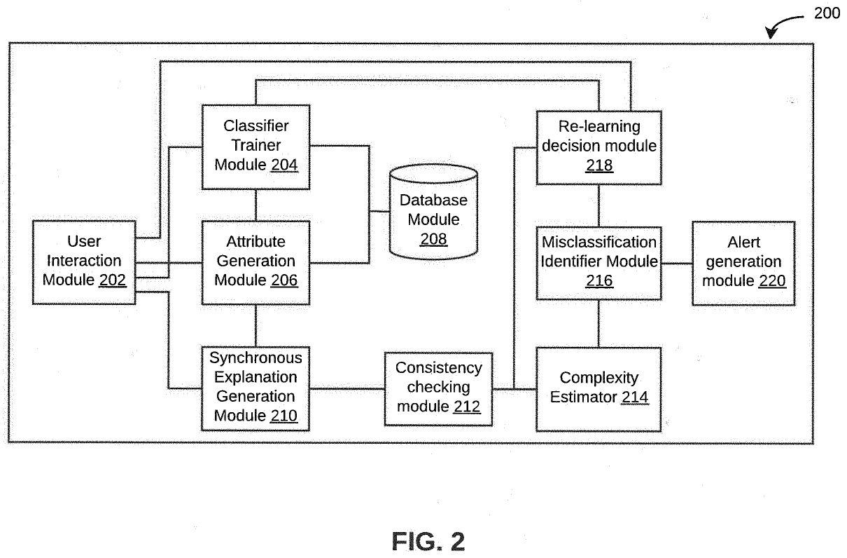

Referring now to FIG. 2, a functional block diagram illustrating an identification engine 200 configured to identify misclassifications by a neural network is illustrated, in accordance with an embodiment. The identification engine 200 may include a user interaction module 202, a classifier trainer module 204, an attribute generation module 206, a database module 208, a synchronous explanation generation module 210, a consistency checking module 212, a complexity estimator 214, a misclassification identifier module 216, a re-learning decision module 218, and an alert generation module 220. As will be appreciated by those skilled in the art, all such aforementioned modules 202-220 may be represented as a single module or a combination of different modules. Moreover, as will be appreciated by those skilled in the art, each of the modules 202-220 may reside, in whole or in parts, on one device or multiple devices in communication with each other.

The user interaction module 202 is communicatively coupled to the re-learning decision module 218, the classifier trainer module 204, the attribute generation module 206, and the synchronous explanation generation module 210. An administrator may provide information associated with a class to the identification engine 200 through the user interaction module 202. For each of a plurality of classes, the administrator may generate a plurality of attributes and an associated textual description. Thereafter, the administrator may provide the plurality of attributes and the associated textual description for each class to the identification engine 200 through the user interaction module 202.

The classifier trainer module 204 may receive the plurality of attributes and the associated textual description for each of the plurality of classes from the user interaction module 202. The classifier trainer module 204 is further communicatively coupled to the relearning decision module 218 and the attribute generation module 206. The classifier trainer module 204 may train the identification engine 200 using the plurality of attributes and the associated textual description for each of the plurality of classes. To this end, the classifier trainer module 204 may perform either an incremental learning or a transfer learning to increase an accuracy of the neural network. The classifier trainer module 204 may also help in determining, whether new classes need to be created.

Once the neural network has been trained for the plurality of classes, the attribute generation module 206 generates a heatmap associated with each of the plurality of layers of the neural network. Thereafter, the attribute generation module 206 generates a plurality of attributes for each of the plurality of classes based on the heatmap associated with the penultimate layer in the plurality of layers. The plurality of attributes may be generated based on an activation value. The attribute generation module 206 may also create a dictionary that includes a mapping of each of the plurality of attributes for a relevant part of the image with an associated textual description. The dictionary also includes a mapping of a neuron Identifier (ID) of a neuron within the penultimate layer with an associated attribute from the plurality of attributes and an associated textual description. Thus, in other words, the attribute generation module 206 may be used to generate a visual explanation and a textual explanation for each of the plurality of attributes for each class.

For each of the plurality of classes, based on the associated heatmap, the attribute generation module 206 may generate an activation value at the penultimate layer. The activation value for the penultimate layer corresponds to a weighted sum of a plurality of neurons in the penultimate layer. Thereafter, for each of the plurality of classes, the attribute generation module 206 may identify a second pattern of triggered neurons in the penultimate layer, based on the activation value generated at the penultimate layer. The attribute generation module 206 is further communicatively coupled to the database module 208 and the synchronous explanation generation module 210.

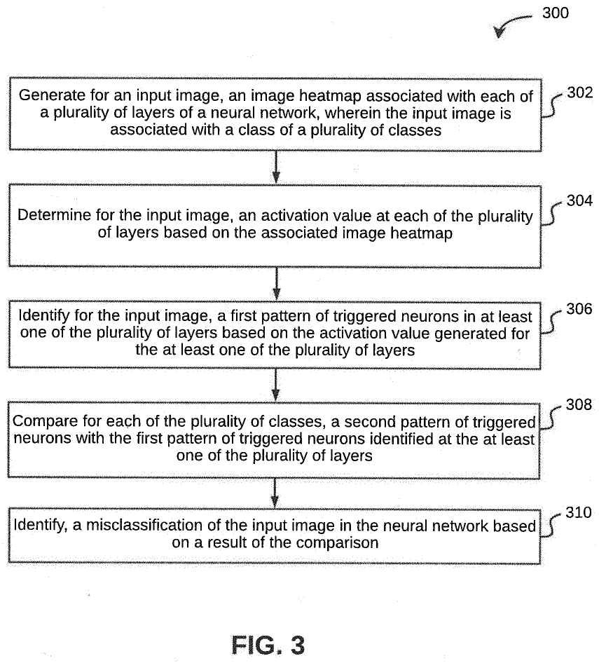

The database module 208 may store the dictionary along with the plurality of attributes, the associated textual and visual explanation or description. After the neural network has been trained, an input image may be provided to the identification engine 200. The input image may be associated with a class of the plurality of classes that were used to train the neural network. For the input image, the synchronous explanation generation module 210 may generate an image heatmap associated with each of a plurality of layers of the neural network. The synchronous explanation generation module 210 may further determine an activation value at each of the plurality of layers based on the associated image heatmap. The activation value for a layer of the plurality of layers corresponds to a weighted sum of a plurality of neurons in the layer. Based on the activation value generated for the one or more of the plurality of layers, the synchronous explanation generation module 210 may further identify a first pattern of triggered neurons in one or more of the plurality of layers for the input image. This is further explained in detail in conjunction with FIG. 3.

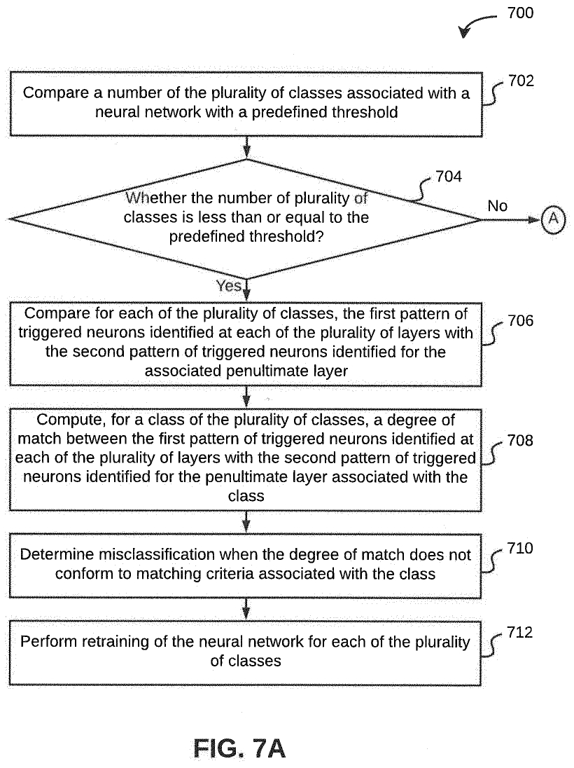

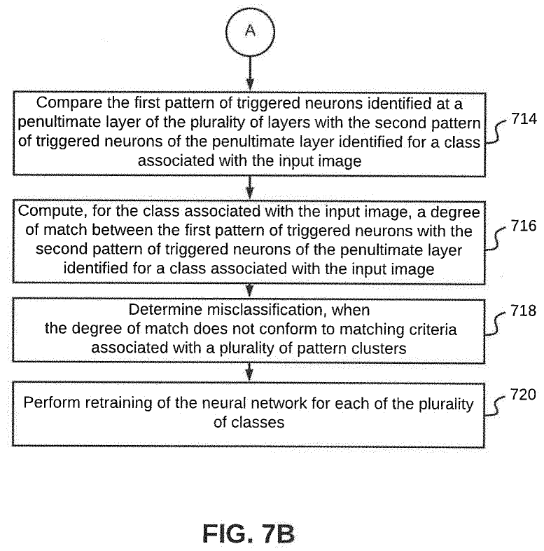

The synchronous explanation generation module 210 is further coupled to the consistency checking module 212. For each of the plurality of classes, the consistency checking module 212 compares the second pattern of triggered neurons with the first pattern of triggered neurons identified at the one or more of the plurality of layers. This is further explained in detail in conjunction with FIGS. 7A and 7B.

The consistency checking module 212 is further coupled to the complexity estimator 214 that may determine whether a simple classification mechanism or a complex classification mechanism is required to classify the input image. To this end, the number of the plurality of classes is compared with a predefined threshold. In an embodiment, when the number of classes is less than or equal to the predefined threshold, it may be determined that the simple classification mechanism is required to be deployed. Alternatively, when the number of classes is greater than the predefined threshold, it may be determined that the complex classification mechanism is required to be deployed. By way of an example, the predefined threshold may be two. In this case, when the number of classes is two or less, the simple classification mechanism may be deployed. Similarly, when the number of classes is more than two, the complex classification mechanism may be deployed. The complexity estimator 214 is further coupled to the misclassification identifier module 216 which may identify a misclassification of the input image, based on the comparison of the first pattern of triggered neurons with the second pattern of triggered neurons. This is further explained in detail in conjunction with FIGS. 7A and 7B.

The misclassification identifier module 216 is further coupled to the re-learning decision module 218 which may determine whether the neural network requires learning or not based on the identified misclassification. The re-learning decision module 218 may also take a decision whether a sub attribute from the plurality of attributes needs to be created. The misclassification identifier module 216 is further coupled to the alert generation module 220, which generates an alert on identification of misclassification by the neural network.

The modules within the identification engine 200 may be connected using wireless or wired communication protocols, which may include, but are not limited to Serial Advanced Technology Attachment (SATA), Integrated Drive Electronics (IDE), IEEE-1394, Universal Serial Bus (USB), fiber channel, Small Computer Systems Interface (SCSI), Simple To Design (STD) Bus, Recommended Standard (RS)-232, RS-422, RS-485, I2C, Serial Peripheral Interface (SPI), Microwire, 1-Wire, IEEE 1284, Intel Quick Path Interconnect, InfiniBand, or Peripheral Component Interconnect Express (PCIe) etc.

Referring now to FIG. 3, a flowchart of a method 300 for identifying misclassifications by a neural network is illustrated, in accordance with an embodiment. The method 300 may be executed by the identification device, which, for example, may include or implement the identification engine 200.

The neural network may be trained interactively by a user, based on prior techniques that may include but are not limited to Alex net, ImageNet, or the like. The neural network may be an iterative image classifier model. For each of these prior techniques, the neural network may include 22 layers, and each layer may include an activation function. Examples of the activation function may include but are not limited to Relu, Softmax, or tank. To start with, a user selects design parameters and a given training dataset. In subsequent iterations, based on the decision taken on learning, misguiding outlier training datasets are eliminated in order to enhance accuracy of the neural network.

In a first iteration, the neural network may be trained as a full-fledged image classifier, based on the given training dataset and a plurality of classes defined by the user. In subsequent iterations, based on the learning efficiency of the neural network, incremental learning or transfer learning may be performed over previous iterations of the neural network. If the neural network needs to learn better in the last few layers, transfer learning is applied. On the other hand, if the training dataset is to be changed or cut down, incremental learning may be applied over the neural network.

Once the neural network is trained as an iterative image classifier model, for an input image, the identification device, at step 302, may generate an image heatmap associated with each of a plurality of layers of the neural network. The input image may be associated with a class of the plurality of classes. In other words, it is already known that the input image belongs to a particular class. The identification device may generate the image heatmap based on standard image heatmap generation techniques. Examples of these techniques may include but are not limited to Layer-wise Relevance Propagation (LRP) techniques, sensitivity analysis, or saliency maps.

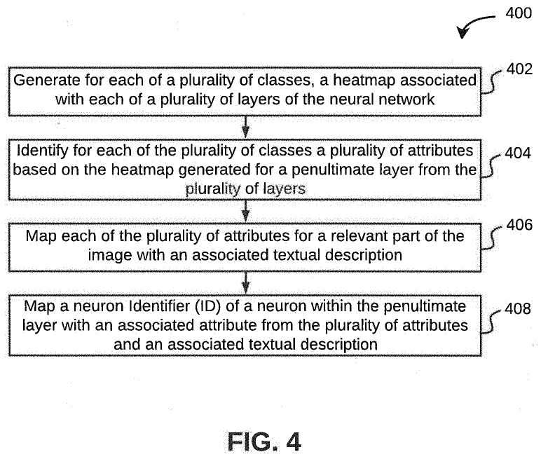

Based on the image heatmap, activation of the neurons in different layers of the neural network may be visualized. Each layer of the plurality of layers may include a plurality of neurons. The last layer of the neural network, for example, may include 34 neurons. To enhance accuracy in the neural network, the identification device, based on the image heatmap, may ignore an irrelevant set of neurons from each of the plurality of layers. Hence, the image heatmap associated with each of the plurality of layers may enable selection of a relevant set of neurons, which may help in determining an activation value at each layer more accurately. This is further explained in detail in conjunction with FIG. 4.

For the input image, the identification device, at step 304, may determine the activation value at each of the plurality of layers based on the associated image heatmap. The activation value may be derived based on an activation function. Thus, the activation value for a layer of the plurality of layers corresponds to a weighted sum of a plurality of neurons in the layer. For the input image, the identification device, at step 306, may identify a first pattern of triggered neurons in one or more of the plurality of layers based on the activation value generated for the one or more of the plurality of layers. This is further explained in detail in conjunction with FIG. 4.

For each of the plurality of classes, at step 308, the identification device may compare a second pattern of triggered neurons with the first pattern of triggered neurons. The second pattern of trigger neurons is generated for the trained neural network. In the trained neural network, for each of the plurality of classes, the second pattern of triggered neurons is identified for a penultimate layer of the plurality of layers, based on the activation value generated at the penultimate layer. At step 310, based on the comparison of the second pattern of triggered neurons with the first pattern of triggered neurons, the identification device may identify a misclassification of the input image in the neural network at step 310. This is further explained in detail in conjunction with FIGS. 7A and 7B.

Referring now to FIG. 4, a flowchart of a method 400 for generating a dictionary that includes a mapping of a plurality of attributes with an associated textual description is illustrated, in accordance with an embodiment. After the neural network has been trained for a plurality of classes, for each of the plurality of classes, a heatmap associated with each of a plurality of layers of the neural network is generated at step 402. This has been explained in detail in conjunction with FIG. 3.

At step 404, for each of the plurality of classes, the plurality of attributes is identified based on the heatmap generated for a penultimate layer in the plurality of layers. In other words, for a given class, only the penultimate layer in the neural network is considered and a heatmap generated for the penultimate layer is used to identify the plurality of attributes. The penultimate layer for a given class may be the layer before an output layer of that class. The plurality of attributes is identified only for the penultimate layer, as in the penultimate layer, the plurality of attributes may be easily and accurately extracted. In an embodiment, for each class, the plurality of attributes may be identified by superimposing a heatmap of the penultimate layer over one or more training images that were used to train the neural network. Outline of the heatmap resembles contours of a training image. The plurality of attributes may be associated with highly relevant parts or regions that contribute to identification of one of the plurality of classes and subsequent classification thereof. These relevant parts or regions, for example, may clearly differentiate images that may be associated with two or more classes. By way of an example, when one of the class is for a fighter plane and the other class is for a passenger plane, relevant parts of the images may include but are not limited to design of the wings, design of the tail, placement of engines, or the number of windows. In an embodiment, each of the plurality of attributes may be text captions that are manually assigned by an administrator.

In an embodiment, for every neuron, about 20 maximum activation generating images from a training dataset may be selected. Caption for these images may be derived using techniques discussed below. The generated captions are then parsed to isolate the adjective or adverb phrases and associated nouns or verbs. Thereafter, the most frequent words or phrases among these labels are identified, A final list of words or phrases identified from attributes of training images predominately contribute to classification of an input image across the plurality of classes.

In an embodiment, one or more regions that are continuous are first identified and highlighted in the heatmap. An outline may be given to the one or more regions in the heatmap. After that, the one or more outlined regions are extracted and a pattern match is done with a training image. Regions for which the match is beyond a threshold, are selected and marked. Subsequently, a user (an expert) provides the attributes for these regions manually.

In another embodiment, after the heatmap is generated, the pixel with maximum relevance is identified. A boundary box with appropriate dimensions may be drawn around the pixel. Thereafter, a next pixel (which would not be a part of the boundary box already drawn) with maximum relevance is identified and the same process is iteratively repeated. The process stops once a required number of regions are identified, Subsequently, a user (an expert) provides the attributes for these regions manually.

In an embodiment, a second pattern of triggered neurons generated using the heatmap may be used. This has been explained in detail in conjunction with FIG. 3. A neuron in the second pattern of triggered neurons, which corresponds to maximum relevance in the penultimate layer (for example) is taken. The neuron is then searched in the heatmap overlaid on the training image to recognize a region with maximum relevance. The shape information for this regions is stored and maintained. The region that has the highest degree of mapping may be marked with a rectangle to help an expert assign attributes to that region. This is repeated for the next neuron with maximum relevance in the penultimate layer. It will be apparent to a person skilled in the art that a layer other than the penultimate layer may be used.

Based on the plurality of attributes, for a relevant part of the image each of the plurality of attributes is mapped to an associated textual description at step 406. The associated textual description may be generated by using a Long Short Term Memory (LSTM) technique. The attributes (or captions) may be trained with visual features and the high relevance of the penultimate layer. In other embodiments, activation values, raw heatmap values, or input image pixel values may be used to generate associated textual descriptions.

In an embodiment, a relevance filter may be used to filter out and use the relevance values that contribute only to a class that is under consideration. This information may be received from the class specific relevance map. In one embodiment, it is multiplied with activations to ensure that the neurons that are triggered are also relevant. In another embodiment, highest relevant values are used. The order of neurons is not changed, i.e., the neurons may be scanned in a fixed order, such that, relevance in descending order are populated at the corresponding position.

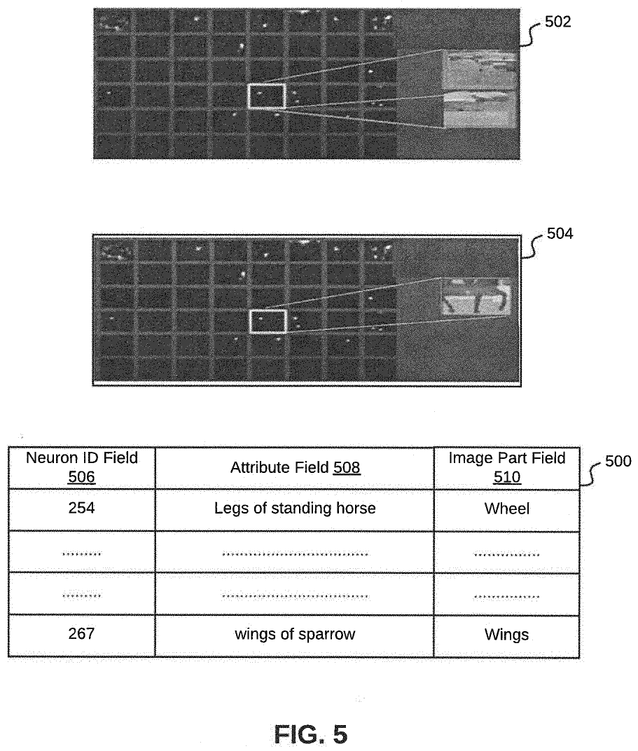

At step 408, a neuron identifier (ID) of each neuron within the penultimate layer may be mapped with an associated attribute from the plurality of attributes, and the associated textual description. Thus, the dictionary may be created for each of the plurality of attributes. This is further explained in detail in conjunction with FIG. 5.

Referring now to FIG. 5, generation of a dictionary 500 using one or more activation images is illustrated, in accordance with an exemplary embodiment. In this exemplary embodiment, the dictionary 500 is generated for an aircraft image classifier that may be used to classify between a passenger class plane and a fighter class plane. For a fighter class plane, a given attribute of the plurality of attributes may be a wheel of plane. The activation images used by the aircraft image classifier for the given attribute may be an image of a fighter class plane and an image of a standing horse. As depicted in 502, for a rectangular area in the image of the fighter class plane, an attribute or caption may be identified as “the wheel of plane.” Similarly, as depicted in 504, for a rectangular area in the image of the standing horse, an attribute or caption may be identified as “legs of a standing horse.” Hence, for the given attribute (the wheel of plane) from the plurality of attribute of the fighter class plane, the textual explanation may also include “legs of a standing horse.”

The dictionary 500 may be maintained for each of the plurality of attributes for each of the plurality of classes associated with the aircraft image classifier. The dictionary 500 may include a neuron ID field 506, which includes ID of a neuron associated with a given attribute, an attribute field 508 that includes an attribute or caption of the activation image, and the image part field 510 that has details of the part of the activation image. By way of an example, in the dictionary 500, the neuron with ID “254” is associated with the attribute “legs of a standing horse,” and the relevant image part in the activation image is the “wheels”.

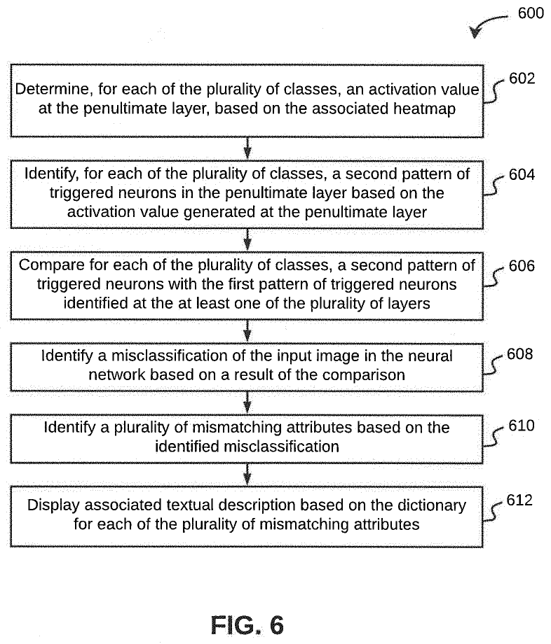

Referring now to FIG. 6, a flowchart of a method 600 for displaying textual description for each of a plurality of mismatching attributes based on a dictionary is illustrated, in accordance with an embodiment. At step 602, for each of a plurality of classes, the activation value at the penultimate layer is determined, based on an associated heatmap. The activation value for the penultimate layer corresponds to a weighted sum of a plurality of neurons in the penultimate layer. Based on the activation value, at step 604, for each of the plurality of classes, a second pattern of triggered neurons is identified in the penultimate layer. The second pattern of triggered neurons may be identified, such that, weight of each neuron in the second pattern of trigger neurons is more than the activation value. In other words, weight of each neuron in the second pattern of triggered neurons is greater than the activation value.

Further, at step 606, for each of the plurality of classes, the second pattern of triggered neurons may be compared with a first pattern of triggered neurons identified at one or more of the plurality of layers for an input image. This is further explained in detail in conjunction with FIGS. 7A and 7B. Based on the comparison, at step 608, a misclassification of the input image by the neural network may be identified. Based on the identified misclassification, a plurality of mismatching attributes may be identified at step 610. The plurality of mismatching attributes may be identified based on relevance value associated with one or more neurons in the first pattern of triggered neurons. Thus, at step 612, based on the dictionary (for example, the dictionary 500), for each of the plurality of mismatching attributes, associated textual description may be displayed. As a result, an administrator may understand the reason for the misclassification.

By way of an example, an aircraft image classifier may be used to classify between the passenger class plane and the fighter class plane. The standard architecture may identify a given input image as the fighter class plane. When the number of neurons (for example, 30 neurons) within the first pattern of triggered neurons of the input image that are similar to the second pattern of the triggered neuron is not above a given matching threshold, then misclassification of the given input image by the aircraft image classifier may be identified. In this case, for the one or more mismatching neurons (or the one or more mismatching attributes) associated textual description is displayed, based on the dictionary (for example, the dictionary 500).

Referring now to FIGS. 7A and 7b, a flowchart of a method 700 for identifying misclassification based on simple classification and complex classification techniques implemented in a neural network are illustrated, in accordance with an embodiment. The neural network may have been trained based on a plurality of classes. At step 702, the number of the plurality of classes may be compared with a predefined threshold. The predefined threshold may be a number (for example, 2). At step 704, a check is performed to determine whether the number of plurality of classes is less than or equal to the predefined threshold. When the number of the plurality of classes is less than or equal to the predefined threshold, it may be identified that the neural network implements a simple classification technique. Thus, at step 706, for a class of the plurality of classes, the first pattern of triggered neurons identified at each of the plurality of layers for an input image may be compared with the second pattern of triggered neurons identified for a penultimate layer associated with that class.

At step 708, for a given class of the plurality of classes, a degree of match between the first pattern of triggered neurons identified at each of the plurality of layers with the second pattern of triggered neurons identified for the penultimate layer associated with the class is computed. When the degree of match does not conform to matching criteria associated with that class, misclassification of the input image is determined at step 710.

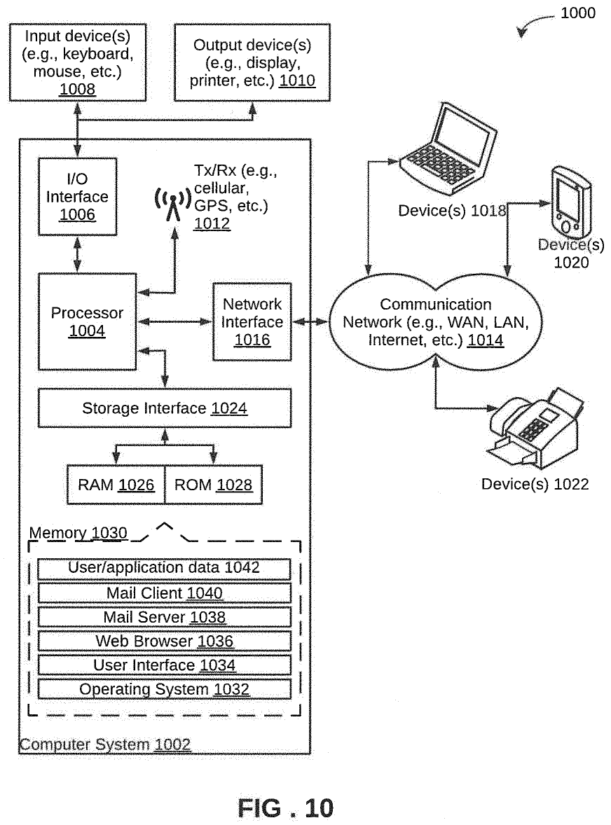

The neural network may have been trained using two classes, i.e., a first class and a second class for example. For a given input image that is associated with the first class, the matching criteria for the first class may be that the degree of match should be greater than an associated predefined threshold. For example, for the given input image the degree of match for the first class should be greater than 60%. Thus, when the degree of match is below 60%, the input image is determined as misclassified. Similarly, the matching criteria for the second class may be that the degree of match should be below an associated predefined threshold. For example, for the given input image the degree of match for the second class should be below 40%. Thus, when the degree of match is equal to or greater than 40%, the input image may be determined as misclassified. The matching criteria for the simple classification technique is further explained in conjunction with an exemplary embodiment given in FIG. 10.

Based on the degree of match, retraining of the neural network may be performed, for each of the plurality of classes, at step 712. In a scenario, for two or more classes, a set of triggered neurons in the first pattern of triggered neuron may match with the associated second pattern of triggered neurons. When the set of triggered neurons is above a matching threshold, for example, 20%, the neural network may need to be retrained by discarding the set of triggered neurons. This may result in increased accuracy of the neural network in classifying input images.

Referring back to step 704, when the number of the plurality of classes is greater than the predefined threshold, it may be identified that the neural network implements a complex classification technique. Thus, at step 714, the first pattern of triggered neurons identified for the input image at the penultimate layer is compared with the second pattern of triggered neurons identified for the class associated with the input image. At step 716, for the class associated with the input image, the degree of match between the first pattern of triggered neurons with the second pattern of triggered neurons may be computed. Further, at step 718, misclassification of the input image is determined when the degree of match does not conform to matching criteria associated with a plurality of pattern clusters. In an embodiment, when it is determined that the neural network implements a complex classification technique, clustering of patterns is done rather than a template match as implemented when the neural network implements a simple classification technique. By way of an example, Modified National Institute of Standards and Technology (MNIST) data classifier may be a neural network that implements complex classification technique.

In an embodiment, a K-means clustering model is developed using activations of the images, reducing the dimensions with Latent Dirichlet Allocation (LDA) and scaling as the pre-processing steps. The misclassified images are then passed through this clustering model. In one implementation, with the Convolution Neural Network (CNN) model in spite of 99.2% accuracy and this method as the post-processing step, it may be possible to catch 75 out of the 150 misclassified images. It may further increase the accuracy of the classifier model.

In another embodiment, relevance of the classes is used instead of activation. The array of relevance is sorted (relevance of an image with respect to each digit), the difference between the relevance of the first class and the second class is set as high threshold to detect potential misclassification. For example, for the same MNIST dataset, the difference may be 4. If the number of outliers in the activation pattern of the last step is more, it indicates fundamental deviation from the main class. Another level of clustering may be tried among the outliers. The existence of the secondary clusters gives the presence of datasets with slightly different features. In the next step, a call may be taken if they are qualified to be classified as a new class of data. For example, in MNIST data set different subclasses are possible within a class from the activation patterns, i.e., a right slanted zero may have a particular pattern, which is different from a left slanted zero. This gives many patterns within a class. This is iterated over the whole data set to collect images with similar activation patterns.

In another embodiment, only the class, to which a sample data point is classified, is considered. All relevance or activation patterns of this class are grouped thereby setting a threshold. Outliers fall beyond this threshold. For a text image, relevance or activation is generated and checked, when it falls in the class suggested by the classifier. If not, it would be treated as misclassification and an alert is generated. To start with, the threshold may be chosen randomly so that at least 80% patterns of the class get clustered. The f score (or false positives and negatives) are computed. The threshold is increased in fine steps to check the improvement. If it becomes better, the threshold is increased, else the threshold is reduced from the original value until no improvement is seen. The steps that are taken maybe 10% of initial average radius of the cluster. By way of an example, the classifier for handwritten digits (i.e., MNIST dataset) may be considered. In this example, the input data is misclassified as “1”, although it is “9”. The cluster of digit “1” is now selected and the patterns (activation/relevance) of input are searched in this cluster. However, they may not be matching in this cluster, hence, there may be a potential misclassification.

Thereafter, based on the degree of match, retraining of the neural network may be performed, for each of the plurality of classes, at step 720. In an embodiment, in order to retrain the neural network, remote outliers determined in the above steps may be discarded, as learning from their presence increases the possibility of misclassification. Also, if the secondary class includes a significant size of feature vectors, a new class is to be carved out and retrained with the training dataset. In one implementation, the size can be 30% of main cluster. The percentage overlap of feature points of two or more classes determine if the data points are to be discarded and the model is to be retrained. In one implementation, a threshold of 20% overlap qualifies for discard.

In another embodiment, the degree of overlap between heatmaps of a class and its complementing classes may determine whether retraining of the neural network is required or not. If there is a 20% or more overlap, the neural network may be required to be retrained with reduced dataset by discarding the overlapping data. The complementing class relevance may be predicted by making the other than predicted class relevance as “1” and the predicted as “0” (when the neural network is trained using two classifiers). It provides the significance (chances of being selected) of that class. To change or rectify the misclassification, it is required only to change those part of the relevance heatmap which are got from taking negative relevance. This, in turn, dictates the choice of test cases. By way of an example, if a passenger plane image is accurately classified while calculating relevance if the passenger class value is set as “0” and fighter class value as “1”, the heatmap will show the significance of being fighter plane. In a first heatmap, when actual relevance is taken, the pixel contributing for passenger class is shown, i.e., passenger as “1” and fighter as “0”. In a second heatmap, when negative relevance is taken, pixel contributing for fighter class is shown, i.e., passenger as “0” and fighter as “1”. In another embodiment, unique patterns of attributes in text explanation of a class may be used to determine if retraining is required or not. If the attributes associated with two images are distinct or partially distinct (for example, more than 60% different), they are placed under distinct subclasses.

By way of an example of the above method, a driver may be driving an autonomous car. The car may read traffic signs and may act based on the reading. For example, the car may change speed based on speed limit signs and direction based on direction sign boards. The car may erroneously increase speed from 90 km/hr to 120 Km/hr, instead of taking a left hairpin bend, based on the signboard ahead. The driver may want an explanation as to why the car took a wrong decision of increasing the speed. To solve this problem, based on the above method, an image of the signboard last encountered by the car, a heatmap of the signboard, and an English explanation for the decision (i.e., increase in speed) may be provided to the driver. From the explanation, it may become evident that the direction signboard is misclassified as speed signboard of 120 km/hr. The signboard was misread, as the image had a glare due to light from a tall vehicle behind the car that occluded the upper part of the signboard. Based on this analysis, the car may be fitted with a night vision camera to prevent reoccurrence of such problems.

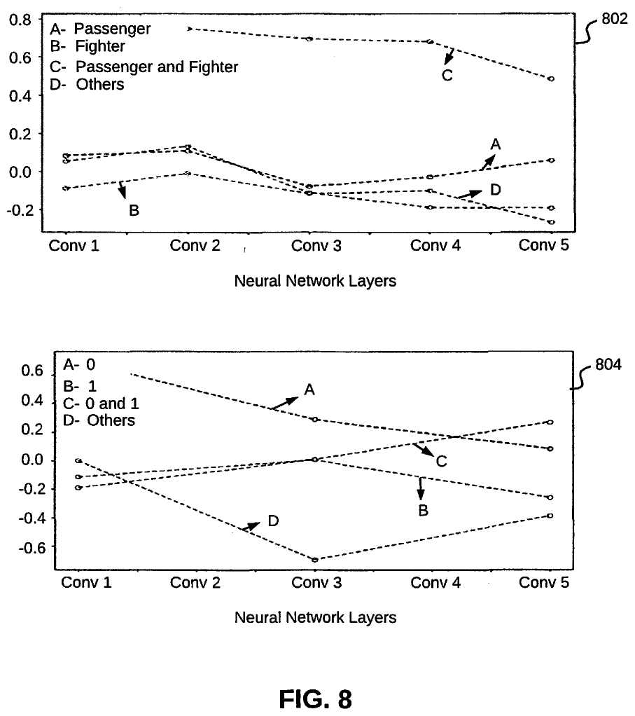

Referring now to FIG. 8, a graph 802 depicting layer-wise learning for a neural network with simple classification and a graph 804 depicting layer-wise learning for a neural network with complex classification is illustrated, in accordance with an exemplary embodiment. The neural network with simple classification may be an aircraft image classifier. The aircraft image classifier may be used to classify between the passenger class plane and the fighter class plane.

In this exemplary embodiment, relevance of each layer is generated for trained images. For each layer, the average of relevance for filters and for all training images pertaining to each class is obtained. The top 30 high relevant filters (30 highest of average relevance values) are identified for each layer. Only 30 filters were considered based on the intuition or observation that the relevance values of filters beyond top 30 filters get closer to zero and difference between adjacent filters is very less when sorted in ascending order of relevance values. Similarly, a commonly occurring sequence of high relevant 30 filters for each layer is obtained from the ordered list of high relevant filters. With these top 30 filters, average relevance and common sequence for each layer are identified. For a given test image, the relevance of each layer is sorted in ascending order.

The exemplary graph may be plotted for the plurality of the first pattern of triggered neurons associated with the input image, matching with the passenger class plane, matching with the fighter class plane, matching with both the fighter class plane and the passenger class plane and matching with none of the fighter class plane and the passenger class plane. In the graph, X-axis may represent the plurality of the layers of the input image and Y-axis may represent the relevance value associated with the plurality of the first pattern of triggered neuron.

In the graph 802, the relevance value of the first pattern of triggered neurons increases towards the last layer for the passenger class plane and the relevance value of the first pattern of triggered neurons decreases towards the last layer for the fighter class plane. In the graph 802, the y-axis may represent relevance across layers and x-axis may represent layers of the neural network.

The neural network with complex classification may be an MNIST digit classifier. The MNIST digit classifier may be used to classify digits from zero to nine. Therefore, each of the digits may be considered as a class. The graph 804 may be plotted for the first pattern of triggered neurons associated with the input image, matching with a digit “0”, matching with a digit “1”, matching with both the digits “0” and “1”, and not matching with any of the digits “0” and “1”. In the graph 804, the relevance value of the first pattern of triggered neurons for both digits “0” and “1” may decrease towards the last layer. In the graph 804, the y-axis may represent relevance across layers and x-axis may represent layers of the neural network.

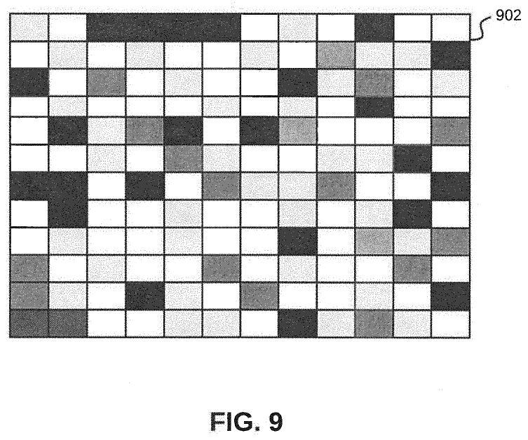

Referring now to FIG. 9, a graph 902 representing activation and relevance of neurons in a neural network with simple classification to identify misclassification in the neural network is illustrated, in accordance with an exemplary embodiment. The misclassification in the neural network may be detected based on relevance values for neurons. In the simple classification, misclassification may be identified by comparing the first pattern of triggered neurons with the second pattern of triggered neuron. In an embodiment, each filter (starting with highly relevant) is compared against a set of top 30 filters identified for each class. If there are n classes, there may be nc1+nc2+ . . . , ncn+1 combinations of buckets. For example, in a 2-class classifier, say a classifier for airplane model as passenger plane or fighter plane, there may be 2c1+2c2+1=4 combinations.

Four buckets of filters namely pure passenger, pure fighter, passenger fighter, and others may be created. The pure passenger bucket includes all filter numbers which matched with one of the top 30 filters for the class passenger. The pure fighter bucket includes all filter numbers that matched to one of the top 30 filters for the class fighter. The passenger fighter bucket includes all filter numbers that matched with the filter which belonged to the top 30 filters for both the classes, i.e., the passenger and the fighter class. The other bucket includes all filter numbers that did not match to any of the top 30 filters for either the passenger class or the fighter class.

In the graph 902, 144 neurons of the first pattern of triggered neurons may be identified and a color may be assigned to each bucket. The pure passenger bucket may be represented by white color, which is 67 in number, the pure fighter bucket may be represented by black color, which is 23 in number, the passenger fighter bucket may be represented by dark grey color, which is 20 in number, and the other bucket may be represented by light grey color, which is 34 in number. Based on the graph 902, it may be determined that the neural network (or the aircraft image classifier) may identify the input image as the passenger class plane.

In a CNN, the final prediction of class would predominately dependent upon the features it would have learned at each layer. If the test image is predicted as belonging to a passenger plane, it would have predominately learned more of passenger features across layers. The total number of filters in each bucket would be directly proportional to the class it belongs. The more the number of filters in particular bucket, it would mean that it belongs to that particular class. The pure passenger bucket may include more number of filters for each layer, if the tested image belongs to passenger class and the same is true for the pure fighter bucket, if the test image belongs to the fighter class. If it is found that the number of filters in pure passenger and pure fighter buckets are not proportional, then it would give an insight for potential mis-classification.

In another embodiment, activations for a random subset of data set images may be obtained. From this, the activation pattern for each class can be observed by summing and averaging. In one example, 5% of training set data may be used. In a binary classifier where the classes are distinct, the patterns may be unique for each class. In fully connected layers, the neurons which get activated for each class behave in the same way, i.e., a template is obtained by collecting the activation records and averaging them over a considerable set of images and setting a threshold. This gives a set of pure neurons for each class. Mixed neurons may get activated for more than one class, i.e., when classes have some common features. This set of neurons get activated with a high value for every single image of that class and they do not get activated for the images of any other classes. Pure neurons recognize distinguishing features of the respective classes.

For a random test image, the activations are collected from forward path by passing it through the model. The similarity of the activation patterns that the test image possesses with the template activation patterns of each class is computed by comparison, i.e., number of positional match in neurons. The right classified images match with only one of the class to a large extent (˜90%). Misclassified images do not follow this rule and they match with more than one class with a very low similarity level.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The disclosed methods and systems may be implemented on a conventional or a general-purpose computer system, such as a personal computer (PC) or server computer. Referring now to FIG. 10, a block diagram of an exemplary computer system 1002 for implementing various embodiments is illustrated. Computer system 1002 may include a central processing unit (“CPU” or “processor”) 1004. The processor 1004 may include at least one data processor for executing program components for executing user or system-generated requests. A user may include a person, a person using a device such as those included in this disclosure, or such a device itself. The processor 1004 may include specialized processing units such as integrated system (bus) controllers, memory management control units, floating point units, graphics processing units, digital signal processing units, etc. The processor 1004 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. The processor 1004 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The processor 1004 may be disposed in communication with one or more input/output (I/O) devices via an I/O interface 1006. The I/O interface 1006 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), W Max, or the like), etc.

Using the I/O interface 1006, the computer system 1002 may communicate with one or more I/O devices. For example, an input device 1008 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 1010 may be a printer, fax machine, video display (for example, cathode ray tube (CRT), liquid crystal display (LCD), light-emitting diode (LED), plasma, or the like), audio speaker, etc. In some embodiments, a transceiver 1012 may be disposed in connection with the processor 1004, The transceiver 1012 may facilitate various types of wireless transmission or reception. For example, the transceiver 1012 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, the processor 1004 may be disposed in communication with a communication network 1014 via a network interface 1016. The network interface 1016 may communicate with the communication network 1014. The network interface 1016 may employ connection protocols including, without limitation, direct connect, Ethernet (for example, twisted pair 50/500/5000 Base T), transmission control protocol/internet protocol (TCP/IP), token ring, IEEE 802.11a/big/nix, etc. The communication network 1014 may include, without limitation, a direct interconnection, local area network (LAN), wide area network (WAN), wireless network (for example, using Wireless Application Protocol), the Internet, etc, Using the network interface 1016 and the communication network 1014, the computer system 1002 may communicate with devices 1018, 1020, and 1022. These devices 1018,1020, and 1022 may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, the computer system 1002 may itself embody one or more of these devices 1018, 1020, and 1022.

In some embodiments, the processor 1004 may be disposed in communication with one or more memory devices (for example, RAM 1026, ROM 1028, etc.) via a storage interface 1024. The storage interface 1024 may connect to memory 1030 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 1030 may store a collection of program or database components, including, without limitation, an operating system 1032, user interface application 1034, web browser 1036, mail server 1038, mail client 1040, user/application data 1042 (for example, any data variables or data records discussed in this disclosure), etc. The operating system 1032 may facilitate resource management and operation of the computer system 1002. Examples of the operating systems 1032 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU™, etc.), IBM® OS/2 platform, MICROSOFT® WINDOWS® platform (XP, Vista/7/8, etc.), APPLE® IOS® platform, GOOGLE® ANDROID® platform, BLACKBERRY OS platform, or the like. The user interface 1034 may facilitate display, execution, interaction, manipulation, or operation of program components through textual or graphical facilities. For example, the user interface 1034 may provide computer interaction interface elements on a display system operatively connected to the computer system 1002, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language. AJAX® programming language, HTML, ADOBE® FLASH® platform, etc.), or the like.

In some embodiments, the computer system 1002 may implement a web browser 1036 stored program component. The web browser 1036 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. The web browsers 1036 may utilize facilities such as AJAX. DHTML, ADOBE® FLASH® platform, JAVASCRIPT® programming language, JAVA® programming language, application programming interfaces (APIs), etc. In some embodiments, the computer system 1002 may implement a mail server 1038 stored program component. The mail server 1038 may be an Internet mail server such as MICROSOFT® EXCHANGE® mail server, or the like. The mail server 1038 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. The mail server 1038 may utilize communication protocols such as internet message access protocol (IMAP), messaging application programming interface (MAPI). Microsoft Exchange, post office protocol (POP), simple mail transfer protocol (SMTP), or the like. In some embodiments, the computer system 1002 may implement a mail client 1040 stored program component. The mail client 1040 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, the computer system 1002 may store user/application data 1042, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

As will be appreciated by those skilled in the art, the techniques described in the various embodiments discussed above are not routine, or conventional, or well understood in the art. The techniques discussed above provide for identifying misclassifications by a neural network by comparing the first pattern of triggered neurons to the second pattern of triggered neurons. The techniques may improve the accuracy of the neural network in identifying misclassification. Moreover, the techniques may ensure consistency in the explanation from the different modalities of explanation and identifies the misclassification to reduce the errors creeping into the system.

Various embodiments provide method and system for identifying misclassification in a neural network. The provided method combines the visual (heatmap based) and text based explanation to achieve synchronism among them although they are generated independently. The layer-wise heatmap is iteratively used to select the right training data that in turn affects model activations (and their visualizations). Consistency in explanation is confirmed before using it for iteratively retraining a classifier model in order to reduce misclassifications and to enhance detectability and learnability. Retraining may largely be dependent on insights got from the explanation. In particular, the method may improve learnability of the plurality of attributes in the classifier and minimizes errors through targeted relearning. The method may improve testability of the system and identifies sub attributes from the plurality of attributes. The proposed method may create the dictionary linking the heatmap of input image, the textual explanation and the textual description for each of the plurality of attributes. The dictionary may help the administrator to understand the reason for the misclassification. Moreover, the proposed method may identify the plurality of attributes based on the relevance value making the neural network to follow more trained path than random stuff.

The specification has described method and system for identifying misclassification in a neural network. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of identifying misclassification in a neural network, the method comprising:
generating for an input image, by an identification device, an image heatmap associated with each of a plurality of layers of a neural network, wherein the input image is associated with a class of a plurality of classes;
determining for the input image, by the identification device, an activation value at each of the plurality of layers based on the associated image heatmap, wherein the activation value for a layer of the plurality of layers corresponds to a weighted sum of a plurality of neurons in the layer;
identifying for the input image, by the identification device, a first pattern of triggered neurons in at least one of the plurality of layers based on the activation value generated for the at least one of the plurality of layers;
comparing for each of the plurality of classes, by the identification device, a second pattern of triggered neurons with the first pattern of triggered neurons identified at the at least one of the plurality of layers, wherein, for each of the plurality of classes, the second pattern of triggered neurons is identified for a penultimate layer of the plurality of layers, based on an activation value generated at the penultimate layer; and
identifying, by the identification device, a misclassification of the input image in the neural network based on a result of the comparison.

2. The method of claim 1 further comprising:
generating, for each of the plurality of classes, a heatmap associated with each of the plurality of layers of the neural network;
generating a plurality of attributes for each of the plurality of classes based on the heatmap associated with the penultimate layer; and
creating a dictionary comprising:
a mapping of each of the plurality of attributes for the relevant part of the input image with an associated textual description; and
a mapping of a neuron Identifier (ID) of a neuron within the penultimate layer with an associated attribute from the plurality of attributes and an associated textual description.

3. The method of claim 2 further comprising:
identifying a plurality of mismatching attributes based on the identified misclassification; and
for each of the plurality of mismatching attributes, displaying associated textual description based on the dictionary.

4. The method of claim 1 further comprising:
determining, for each of the plurality of classes, an activation value at the penultimate layer, based on the associated heatmap, wherein the activation value for the penultimate layer corresponds to a weighted sum of a plurality of neurons in the penultimate layer; and
identifying, for each of the plurality of classes, the second pattern of triggered neurons in the penultimate layer based on the activation value generated at the penultimate layer.

5. The method of claim 1 further comprising comparing a number of the plurality of classes with a predefined threshold.

6. The method of claim 5, further comprising comparing, for each of the plurality of classes, the first pattern of triggered neurons identified at each of the plurality of layers with the second pattern of triggered neurons identified for the associated penultimate layer, when the number of the plurality of classes is less than or equal to the predefined threshold.

7. The method of claim 6, wherein determining misclassification comprises:
computing, for a class of the plurality of classes, a degree of match between the first pattern of triggered neurons identified at each of the plurality of layers with the second pattern of triggered neurons identified for the penultimate layer associated with the class; and
determining misclassification when the degree of match does not conform to matching criteria associated with the class.

8. The method of claim 5, further comprising comparing the first pattern of triggered neurons identified at a penultimate layer of the plurality of layers with the second pattern of triggered neurons of the penultimate layer identified for a class associated with the input image, when the number of the plurality of classes is greater than the predefined threshold.

9. The method of claim 8, wherein determining misclassification comprises:
computing, for the class associated with the input image, a degree of match between the first pattern of triggered neurons with the second pattern of triggered neurons of the penultimate layer identified for a class associated with the input image; and
determining misclassification, when the degree of match does not conform to matching criteria associated with a plurality of pattern clusters.

10. A system for identifying misclassification in a neural network, the system comprising:
a processor; and
a memory communicatively coupled to the processor, wherein the memory stores processor instructions, which, on execution, causes the processor to:
generate for an input image, an image heatmap associated with each of a plurality of layers of a neural network, wherein the input image is associated with a class of a plurality of classes;
determine for the input image, an activation value at each of the plurality of layers based on the associated image heatmap, wherein the activation value for a layer of the plurality of layers corresponds to a weighted sum of a plurality of neurons in the layer;
identify for the input image, a first pattern of triggered neurons in at least one of the plurality of layers based on the activation value generated for the at least one of the plurality of layers;
compare for each of the plurality of classes, a second pattern of triggered neurons with the first pattern of triggered neurons identified at the at least one of the plurality of layers, wherein, for each of the plurality of classes, the second pattern of triggered neurons is identified for a penultimate layer of the plurality of layers, based on an activation value generated at the penultimate layer; and
identify a misclassification of the input image in the neural network based on a result of the comparison.

11. The system of claim 10, wherein the processor is further configured to:
generate, for each of the plurality of classes, a heatmap associated with each of the plurality of layers of the neural network;
generate a plurality of attributes for each of the plurality of classes based on the heatmap associated with the penultimate layer; and
create a dictionary comprising:
a mapping of each of the plurality of attributes for the relevant part of the input image with an associated textual description; and
a mapping of a neuron Identifier (ID) of a neuron within the penultimate layer with an associated attribute from the plurality of attributes and an associated textual description.

12. The system of claim 11, wherein the processor is further configured to:
identify a plurality of mismatching attributes based on the identified misclassification; and
for each of the plurality of mismatching attributes, display associated textual description based on the dictionary.

13. The system of claim 10, wherein the processor is further configured to:
determine, for each of the plurality of classes, an activation value at the penultimate layer, based on the associated heatmap, wherein the activation value for the penultimate layer corresponds to a weighted sum of a plurality of neurons in the penultimate layer; and
identify, for each of the plurality of classes, the second pattern of triggered neurons in the penultimate layer based on the activation value generated at the penultimate layer.

14. The system of claim 10, wherein the processor is further configured to compare a number of the plurality of classes with a predefined threshold.

15. The system of claim 14, wherein the processor is further configured to compare, for each of the plurality of classes, the first pattern of triggered neurons identified at each of the plurality of layers with the second pattern of triggered neurons identified for the associated penultimate layer, when the number of the plurality of classes is less than or equal to the predefined threshold.

16. The system of claim 15, wherein the processor is configured to determine misclassification by:
computing, for a class of the plurality of classes, a degree of match between the first pattern of triggered neurons identified at each of the plurality of layers with the second pattern of triggered neurons identified for the penultimate layer associated with the class; and
determining misclassification when the degree of match does not conform to matching criteria associated with the class.

17. The system of claim 14, wherein the processor is further configured to compare the first pattern of triggered neurons identified at a penultimate layer of the plurality of layers with the second pattern of triggered neurons of the penultimate layer identified for a class associated with the input image, when the number of the plurality of classes is greater than the predefined threshold.

18. The system of claim 17, wherein the processor is configured to determine misclassification by:
computing, for the class associated with the input image, a degree of match between the first pattern of triggered neurons with the second pattern of triggered neurons of the penultimate layer identified for a class associated with the input image; and
determining misclassification, when the degree of match does not conform to matching criteria associated with a plurality of pattern clusters.

19. A non-transitory computer-readable storage medium having stored thereon, a set of computer-executable instructions causing a computer comprising one or more processors to perform steps comprising:
generating for an input image, an image heatmap associated with each of a plurality of layers of a neural network, wherein the input image is associated with a class of a plurality of classes;
determining for the input image, an activation value at each of the plurality of layers based on the associated image heatmap, wherein the activation value for a layer of the plurality of layers corresponds to a weighted sum of a plurality of neurons in the layer;
identifying for the input image, a first pattern of triggered neurons in at least one of the plurality of layers based on the activation value generated for the at least one of the plurality of layers;
comparing for each of the plurality of classes, a second pattern of triggered neurons with the first pattern of triggered neurons identified at the at least one of the plurality of layers, wherein, for each of the plurality of classes, the second pattern of triggered neurons is identified for a penultimate layer of the plurality of layers, based on an activation value generated at the penultimate layer; and
identifying a misclassification of the input image in the neural network based on a result of the comparison.
